(19) United States
(12) Patent Application Publication
(10) Pub. No.: US 2007/0112654 A1
(43) Pub. Date: May 17, 2007

(54) System and Method For Monitoring Home Healthcare Workers

(76) Inventors: Luis Garcia, Slinger, WI (US); Bryan D. Dickerson, Hartford, WI (US); Michael D. Cook, Watertown, WI (US); Nathan A. Schleifer, Grafton, WI (US); Jeffrey H. Peterson, Jackson, WI (US)

Correspondence Address: QUARLES & BRADY LLP, 411 E. WISCONSIN AVENUE, SUITE 2040, MILWAUKEE, WI, 53202-4497, US

(21) Appl. No.: 11/621,371

(22) Filed: Jan. 9, 2007

Related U.S. Application Data
(63) Continuation of application No. 11/207,446, filed on Aug. 19, 2005.

(51) Int. Cl. G07C 1/10; G06F 17/40

(52) U.S. Cl. 705/32; 702/187

(57) ABSTRACT

Healthcare services at a patient's residence are monitored by placing an identification device in the residence and by a healthcare worker carrying a data acquisition device. Whenever proximate to the residence, the data acquisition device receives a wireless signal that carries an identifier from the identification device. The data acquisition device responds to receipt of that wireless signal by recording the identifier and measuring the amount of time that the signal continues to be received. At some later point in time, the information acquired by the data acquisition device is transferred to a computer system for processing and preparation of records about the quality and security of patient care and the time and attendance of the healthcare worker.

### CROSS-REFERENCE TO RELATED APPLICATIONS

This is a continuation in part of U.S. patent application Ser. No. 11/207,446 filed on Aug. 19, 2005.

### STATEMENT REGARDING FEDERALLY SPONSORED RESEARCH OR DEVELOPMENT

Not Applicable

### BACKGROUND OF THE INVENTION

1. Field of the Invention

The present invention relates to time and attendance and staff scheduling systems for monitoring work hours of healthcare workers, and more particularly to a monitoring system that automatically logs when a healthcare worker is present at a residence of a patient being attended to at home.

2. Description of the Related Art

Healthcare workers at a medical facility historically used a time clock to record the time of day on an attendance card upon entering and exiting the workplace. Today computerized time and attendance systems have replaced the traditional time clocks. These systems read an unique employee number and other data from an identification badge when the employee arrives and departs the workplace. The acquired employee identification data are transmitted and recorded in a central computer along with the current date and time. That recorded information is subsequently used by a payroll program (amongst others) to calculate the amount of wages that each employee is to receive.

With rising costs of in-patient medical care, a greater number of patients are receiving care in their homes. In those cases, a healthcare worker periodically attends to the patient at home. Depending upon the needs of a particular patient, the healthcare worker may visit the patient once a week, a few times a week, or on a daily basis. Each visit may be for a short period of time, in which case the healthcare worker visits several patients each day, or the healthcare worker may attend to the patient for an entire eight hour work shift. Because the healthcare worker is visiting the patients' homes, conventional time and attendance and staff scheduling systems can not be used to record the time and monitor the schedule that the particular healthcare worker is working.

Therefore, a need exists for a system that automatically monitors the time and attendance and staff scheduling data of healthcare workers at the homes of patients being treated.

### SUMMARY OF THE INVENTION

Services provided by a healthcare worker at a residence of a medical patient are monitored by an identification device placed in the residence and a data acquisition device carried by the healthcare worker. The identification device, either periodically or in response to activation, emits a first wireless signal that provides a first identifier. In a preferred embodiment, the first identifier is uniquely associated with one particular medical patient or residence.

When proximate to the patient, the data acquisition device receives the first wireless signal and extracts and records the first identifier. Optionally, receipt of the first wireless signal also causes the data acquisition device to record the date and time of day along with the first identifier. In another option, the data acquisition device measures the interval that the first wireless signal continues to be received and when the receiving of that signal ceases, an indication of that interval is stored with the first identifier. Thus the indication represents the amount of time that the healthcare worker provided services to the medical patient. In this manner, the data acquisition device acquires information related to the healthcare worker attending to the medical patient. Similar information can be acquired about other medical patients attended to by this healthcare worker throughout the day.

Thereafter, the acquired information is transferred from the data acquisition device to a computer. Any of several techniques can be employed to perform that transfer. For example, the data acquisition device may respond to receiving an wireless interrogation signal by transmitting the acquired information via another wireless signal to the computer. The wireless signals can be radio frequency signals, light within the infrared or visible spectrums, audible sound, ultrasound, or other forms of wireless communication. A cellular telephone connection, a land line telephone connection or an Internet connection also can be used to transfer the information from the data acquisition device to a computer. A cable connection could even be employed.

The computer processes the information from the data acquisition device to supervise the provision of services to the patient. For example, the information enables to computer to determine when the healthcare worker visited the patient's residence and the length of each visit. This verifies that the worker actually performs the work assignments and provides information for billing the patient. The computer also can prepare a report regarding the treatment received by the patient.

### BRIEF DESCRIPTION OF THE DRAWINGS

FIG. 1 is a schematic diagram of a medical facility computer system that stores patient records, as well as information about hospital employees;

FIG. 2 depicts a healthcare worker attending to a patient in bed at home;

FIG. 3 is a block schematic diagram of an electronic identification device worn by the patient;

FIG. 4 is a block schematic diagram of the data acquisition device carried by the healthcare worker;

FIG. 5 illustrates the healthcare worker adjacent to a personal computer connected to medical facility computer system to transfer data from the data acquisition device into the computer system;

FIG. 6 is a block schematic diagram of a data interrogator connected to a personal computer in the medical facility;

FIG. 7 is a graphical representation of data fields of a treatment event record stored within the hospital computer system; and

FIG. 8 is a block schematic diagram of another embodiment of an electronic identification device worn by the patient.

### DETAILED DESCRIPTION OF THE INVENTION

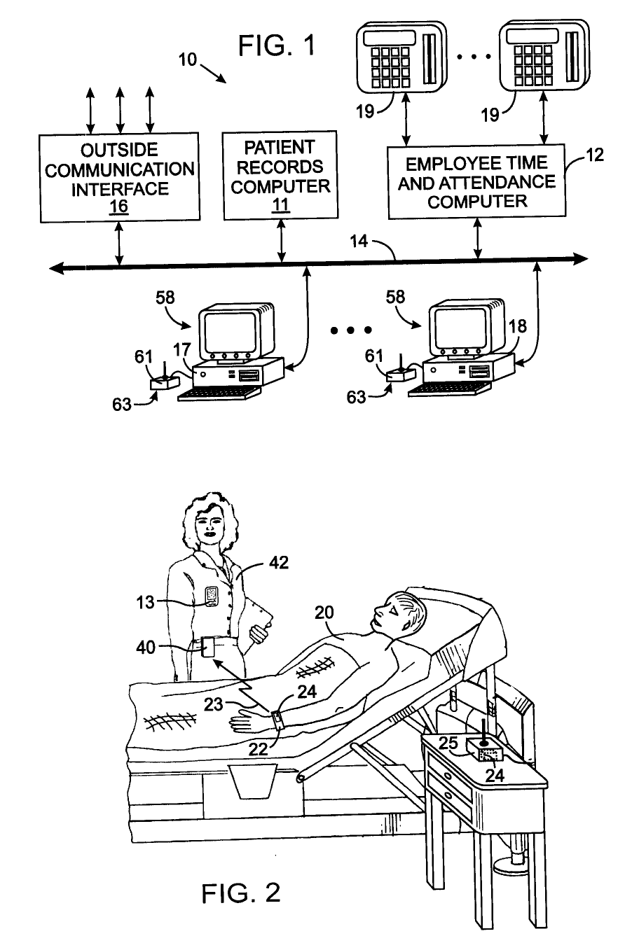

FIG. 1 illustrates a computer system 10 of a medical facility, such as a hospital, outpatient clinic, nursing home, extended care center, or a business office from which home health care workers are supervised, for example. The computer system 10 includes a computer 11, that processes and stores patient records, and a time and attendance computer 12, which executes software programs that schedule employees and then records the actual amounts of time that they work. The patient records computer 11 and the time and attendance computer 12 are connected to a conventional local area network (LAN) 14 of a type commonly found in work places. A plurality of personal computers 17 and 18 are connected to the LAN 14 to exchange data and commands with the computers 11 and 12. It should be understood that many more personal computers than are illustrated are connected to the LAN 14 throughout the medical facility. For example, personal computers are located at nursing stations, treatment areas, and administrative offices. The computer system 10 is typical of a relatively large medical facility, whereas the present invention also can be used where the health care workers are supervised from one or more rooms in an office building. In this latter case computer system 10 could consist of a single personal computer.

Employees working at the medical facility record when they start and end periods of work by using a badge readers 19 located throughout the medical facility and connected to the local area network 14. The badge readers 19 can be any of a number of commercially available types. For example, each employee is issued an identification badge 13 (FIG. 2) that has a magnetic strip or other mechanism which encodes a unique employee identifier (e.g. identification number) and the badge is read by the badge reader 19. This process enters employee time and attendance data into the computer system.

However, the time and attendance data gathering system at the medical facility cannot track healthcare workers who attend to patients at home. Instead, a unique system has been created for those workers. Now when home care is arranged for a patient, an office employee creates a record for that patient within the memory of the patient records computer 11. That record contains standard information, such as the patient's name, home address, biographical information, insurance and other billing information, names of assigned healthcare workers, and the like. Then, as is common practice at most medical facilities, the personal computer 18 prints a label 15 for a wristband that is worn by the patient to provide identification of this patient to healthcare workers.

Unlike that prior practice, the label 15 now is attached to a wristband 22 that contains an electronic identification device 24 depicted in FIG. 2, which emits a first radio frequency signal 23 carrying a unique identifier for this patient. That patient identifier, and a similar identifier to be described for a healthcare worker, may comprise only numerals (i.e. a patient ID number), only alphabetic characters, or a combination of alphanumeric characters, as well as other characters. Although the exemplary identification device 24 is being described as attached to a wristband 22 fastened around the lower forearm of the patient 20, it should be understood that the identification device may be worn about other parts of the patient's body or take other forms.

Because a patient may not desire to wear a wristband at home, the identification device 24 alternatively can be mounted in a housing 25 that is placed at a convenient location within the patient's residence. That location does not have to be close to the patient's bed. Although FIG. 2 illustrates the patient in bed, the present monitoring system also can be used with ambulatory patients who are attended to at home. The housing 25 also may contain a power supply that receives electricity from a wall outlet in the home to power the identification device 24.

Identification device 24 may be preprogrammed with the patient identifier that is the same as or different than the standard identification number assigned to the medical facility patients upon admission. Alternatively, the patient identifier can be programmed into the identification device 24 by the personal computer 18, thereby enabling a single number or other identifier to be used for all identification purposes. In that latter case, the personal computer can download other information about the patient, such as allergies, into the identification device prior to issuance to the patient.

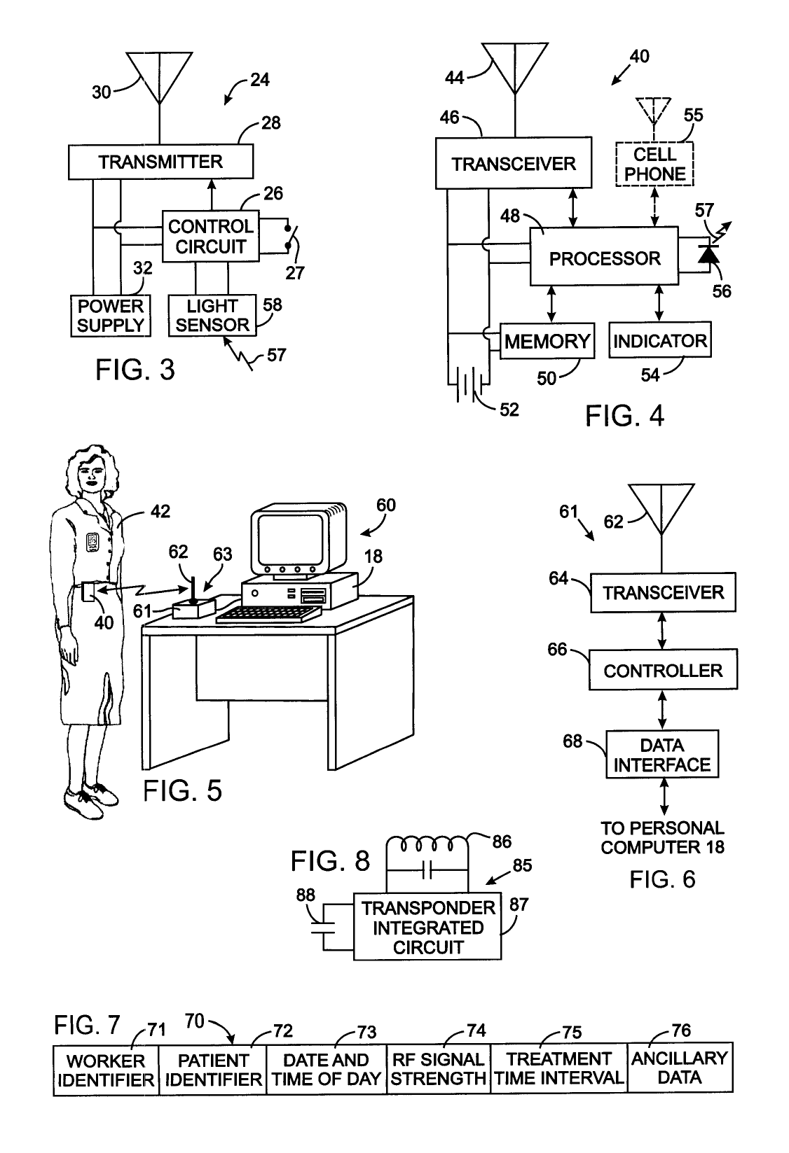

With reference to FIG. 3, the electronic identification device 24 has a control circuit 26 which governs the operation of the device and has the unique patient identifier stored therein. A switch 27, connected to the control circuit, is used to turn on the identification device upon being issued to a patient. When operating, the control circuit 26 periodically activates a radio frequency (RF) transmitter 28 which modulates an RF carrier signal with the patient identifier using any standard modulation technique. The resultant first radio frequency signal is applied to an antenna 30 from which the signal radiates in an omnidirectional pattern. The components of the identification device 24 are connected to a power supply 32 that can be a battery when the identification device is on a wristband or an AC to DC power supply when the device is in housing 25.

Referring again to FIG. 2, the healthcare workers, visiting the patient's home, wear or carry data acquisition devices 40 that receive the first RF signal 23 while attending to the respective patient. For example, the data acquisition device 40 can be worn on the belt or waistband of a healthcare worker 42, such as a physician, nurse, physical therapists, housekeeper, or other care giver. The first RF signal 23 from the patient's identification device 24 may have an effective signal strength within only a few feet around the patient 20 and beyond that limited range the data acquisition devices 40 will not detect that first RF signal. In this case, healthcare worker 42 must be relatively close to the patient in order for the data acquisition device to pick-up a patient's identifier. This arrangement is utilized when monitoring of a healthcare worker in close proximity of the patient is desired. In other situations, where it is desired to monitor when the healthcare worker 42 is anywhere in the patient's home, not just proximate to the patient, the identification device 24 broadcasts the first RF signal 23 in a larger area encompassing the entire residence.

When the monitoring system is configured to record activity only when the healthcare worker 42 is relatively close to the patient, other types of wireless signals can be used instead of the first RF signal 23. Such alternative signals include, light within the infrared or visible spectrums, audible sound, ultrasound and other electromagnetic frequencies. Therefore, the term “wireless signal” as used herein is intended to cover all means of wireless communication.

The data acquisition device 40 also may measure the strength of the first RF signal 23 received from the identification device 24 as indicating the proximity of the healthcare to the patient wearing the device. The RF signal strength in that case indicates the level of treatment being administered, as a relatively high level denotes very close proximity between the worker and the patient, whereas a lower level indicates that the worker is performing other duties in the residence.

With reference to FIG. 4, the data acquisition device 40 includes an antenna 44 that is connected to a transceiver 46, which has a receiver section and a transmitter section. Upon receiving a first RF signal 23 from a patient identification device 24, the transceiver section demodulates that signal and extracts the patient identifier. The patient identifier then is stored by a processor 48 in a memory 50. The processor executes a software program that also is stored in the memory 50 and which controls the operation of the data acquisition device. An indicator 54 is connected to the processor 48 and comprises a light emitting diode, a liquid crystal display or similar component for presenting information about the operation of the data acquisition device to the wearer. A battery powers the components of the data acquisition device 40.

When a healthcare worker 42 is within the range of the first RF signal 23 emitted by an identification device 24, as shown in FIG. 2, the data acquisition device 40 begins receiving the patient identifier. That event causes the processor 48 to record the patient identifier, the date, and time of day in the memory 50. At that time the processor 48 also starts a software based timer to measure the time period during which the healthcare worker attends to the particular patient 20. That timer is active as long as the data acquisition device 40 continues to receive periodically the first radio frequency signal 23 containing the same patient identifier. Since the patient identification device 24 transmits the first radio frequency signal at predetermined intervals, if a defined number of intervals pass without receiving a radio frequency signal, the data acquisition device 40 concludes that a healthcare worker 42 is no longer attending to the patient. Upon reaching that conclusion (which can also be reached through analysis of the recorded data), the processor 48 terminates the timer and stores the timer's final value into a location in memory 50 that is associated with the most recently stored patient identifier. Thus, the memory 50 now contains a patient data set comprising an indication of the patient, the date and time of day, RF signal strength, and the amount of time that the healthcare worker attended to that person. The determination that the healthcare worker 42 no longer is attending to the patient is based on analysis of recorded data or ceasing to receive the first RF signal 23, which in the case of a periodically transmitted, or pulsed, signal is not merely when no signal is received, as that occurs between pulses, but rather when a pulse is not received for a given amount of time that is longer than the pulse cycle.

Thereafter, if the healthcare worker 42 reenters the range of the first RF signal 23, a new set of storage locations within memory 50 are employed to retain another patient data set of a patient identifier, the date and time of day, RF signal strength, and an amount of treatment time.

When that same healthcare worker 42 goes to another residence, a new patient's identifier is obtained from the first radio frequency signal transmitted by a different identification device 24 and new treatment data is stored in the healthcare worker's data acquisition device 40. Over the course of time, the data acquisition device 41 worn by a healthcare worker 42 will contain the patient data sets for each person to whom care is provided.

A given residence may have more that one patient who is being attended to by the same healthcare worker 42. As noted previously, the first RF signal 23 from the patient's identification device 24 has an effective signal strength only several feet around the patient 20 and beyond that range the data acquisition devices 40 will not detect the signal. That limited signal range reduces the likelihood of a data acquisition device 40 simultaneously receiving signals from two or more patients. The data acquisition device 40 is configured so that as long as an RF signal continues to be received from one identification device 24, as determined based on the patient identification number carried by that signal, RF signals from other identification devices will be ignored. The RF signal strength can be employed to differentiate between signals that are received simultaneously from two or more identification devices 24 in which case the strongest signal is selected as likely received from the patient being treated.

Other information stored in the patient identification device 24 also is transmitted to the data acquisition device 40 along with the patient identifier. For example, information indicating allergies of the patient can be displayed to the medical facility worker on indicator 54 of the data acquisition device 40. The data acquisition device also may receive data, such as temperature and heart rate, from portable monitors carried by the patient. Such ancillary data is stored in the data acquisition device 40 as part of a patient's data set for subsequent transfer to the patient records computer 11, as will be described.

The patient identification device 24 periodically transmitting the patient identifier consumes electrical power even though a healthcare worker is not visiting the patient, which may be the vast majority of the time. As a variation to conserve power, especially for a battery powered identification device, the data acquisition device 40 in FIG. 4 includes one or more infrared light emitters, such as LED 56. The processor periodically activates the light emitter, which produces a wide beam 57 of infrared light. The patient identification device 24 in FIG. 3 has an infrared light sensor 58 that responds to receiving the light beam 57 from the data acquisition device 40 by commencing periodic transmission of the patient identifier. Those transmissions continue for a short interval after the light beam no longer is received thus tolerating brief periods when the light beam may be blocked while the healthcare worker is attending to the patient.

Referring to FIGS. 1 and 5, the data stored in the data acquisition device 40 are transferred to the computer system 10 at the medical facility via a plurality of data readers 63 connected to the LAN 14. In addition, another data reader 63 can be connected to a personal computer at another location, such as the home of the healthcare worker 42, from which data can be transferred to the medical facility via a telephone line or an Internet connection to an outside communication interface 16 connected to the LAN 14. Each data reader 63 comprises a data interrogator 61 connected to a personal computer 17 or 18 which is configured as patient information transfer station 60. The data interrogator 61 acquires the stored information from the healthcare worker's data acquisition device 40 and conveys that information to the personal computer.

With additional reference to FIG. 6, the data interrogator 61 has an antenna 62 connected to a radio frequency transceiver 64 which exchanges commands and data with a controller 66 and passes that data through a data interface 68 to the personal computer 18. Although communication between the data interrogator 61 and the data acquisition device 40 is being described in the context of radio frequency signals, other types of wireless signals can be used, including for example light within the infrared or visible spectrums, audible sound, ultrasound and other electromagnetic frequencies.

Periodically, such as every second or two, the interrogator 61 transmits a radio frequency signal modulated with an interrogation command. When a healthcare worker 42 is within approximately ten feet of the interrogator 61, that person's data acquisition device receives and responds to the interrogation command. With reference to FIG. 4, the transceiver 46 in the data acquisition device 40 extracts the interrogation command from the received radio frequency signal and the command is sent to the processor 48. Upon receiving an interrogation command, the processor 48 executes a software routine which reads memory 50 to obtain a unique identifier that was assigned to the associated data acquisition device 40. This identifier specifies the particular data acquisition device 40 as well as the healthcare worker 42 to whom the device was issued and thus is referred to as a “worker identifier”. The worker identifier is sent to the transceiver 46 which modulates a radio frequency carrier with that identifier and applies the resultant second radio frequency signal to the antenna 44. Then the processor 48 sequentially (or in packet form) transfers the patient data sets from memory 50 to the transceiver 46 which transmits that data via the second radio frequency signal. Thus, the data acquisition device 40 responds to the interrogation command by transmitting a return signal that contains its healthcare worker's identifier and the patient identification and treatment time information stored within the memory 50.

That return signal is received by the interrogator antenna 62 and applied to the receiver section of the transceiver 64 in FIG. 6. The transceiver 64 demodulates the received signal extracting the information carried by the return signal. The worker identifier and each patient data set are transferred through the data interface 68 to the personal computer 18. The personal computer temporarily stores the information received from the data acquisition device as a series of treatment event records 70, one of which is graphically depicted in FIG. 7. Each treatment event record 70 contains the worker identifier field 71, a patient identifier field 72, date and time of day field 73, an RF signal strength measurement field 74, a treatment time interval field 75 and an ancillary data field 76, if needed. After all the patient treatment information has been transferred, the patient data is erased from the data acquisition device 40. The personal computer 18 transfers the acquired patient treatment information to the patient records computer 11.

Alternatively, the data interrogator may comprise a cable, that during data transfer, physically connects the personal computer 18 to a data acquisition device 40. A software routine executed by the personal computer 18 issues an interrogation command via the cable to the data acquisition device and obtains the patient treatment information. Other types of data interrogators that perform this function can be employed.

As a further alternative in FIG. 4, the data acquisition device may contain a cellular telephone 55 in which case the processor 48 is programmed to call, at a specific time of day, a telephone number connected to the outside communication interface 16 at the medical facility. After that connection is made the patient data sets are transferred to the computer system 10 at the medical facility.

The patient records computer 11 parses the treatment information, received from the data readers 63, based on the patient identifiers and stores that information in separate data records for each patient. Each such record for a given patient has data showing which healthcare worker treated that patient and the duration of each treatment. This patient treatment information then can be analyzed to determine the total time of treatment each patient received and the amounts of time that the particular patient was treated by each different class of healthcare worker, such as a physician, nurse, physical therapist, housekeeper, etc. Reports related to patient treatment are prepared by the computer system 10.

The patient treatment information also is transferred to the employee time and attendance computer 12 which tabulates the information based on the worker identifier associated with each treatment event record 70 from the data acquisition devices 40. Thus, a record for a particular healthcare worker stored within the memory of the time and attendance computer 12 contains information identifying each patient that the respective healthcare worker treated and the amount of time of such treatments. This information can be analyzed to determine the total amount of treatment provided by a particular healthcare worker and the amount of pay due that person. The present monitoring system also verifies that the healthcare worker actually visited a particular patient to whom he or she is assigned for quality and security of patient care. Reports related to the healthcare workers job performances are prepared by the computer system 10.

FIG. 8 depicts second type of electronic patient identification device 85 for incorporation into the wristband 22 of the patient 20. This second identification device is passive in that it does not require a power source, such as a battery. Instead, the second patient identification device 85 comprises a conventional radio frequency transponder tag, such as the type that is commonly used to identify products or used as a key-card for a building entry system. The second patient identification device 85 has an antenna 86 that is part of a tuned, resonant circuit connected to a transponder integrated circuit 87 which may be any one of a number of commercially available devices, such as one of a family of products available from Texas Instruments Incorporated, Dallas, Tex., USA. The transponder integrated circuit 87 is powered by energy derived from a radio frequency signal received at antenna 86 and used to store a charge on a capacitor 88. That stored charge provides a voltage for powering the electronic circuits. Because the second patient identification device 85 does not require power from a battery, it can be utilized with patients requiring long term care or who will be permanent residents of a nursing facility.

For use with the second patient identification device 85, the data acquisition device 40 in FIG. 4 carried by a healthcare worker 42 is modified to periodically, every second or so, emit a third radio frequency signal to which the second patient identification device 85 is tuned. Upon receiving that third radio frequency signal, the transponder integrated circuit 87 becomes energized by power derived from that signal. This causes the second patient identification device 85 emit the first radio frequency signal that carries the unique patient identifier which is stored within the transponder integrated circuit 87. The data acquisition device 40 processes the patient identifier in that same manner as described previously.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A method for monitoring services provided by a healthcare worker at a residence of a medical patient, said method comprising:
placing an identification device in the residence wherein the identification device wirelessly emits a first wireless signal providing a first identifier;
issuing a data acquisition device to a healthcare worker;
when proximate to the residence, the data acquisition device receiving the first wireless signal;
the data acquisition device recording the first identifier provided by the first wireless signal; and
thereafter, transferring the first identifier from the data acquisition device to a computer.

2. The method as recited in claim 1 wherein the first wireless signal carries a unique identification number.

3. The method as recited in claim 1 wherein the identification device periodically emits the first wireless signal.

4. The method as recited in claim 1 further comprising the data acquisition device recording date and time of day that the first signal is received.

5. The method as recited in claim 1 further comprising the data acquisition device recording an indication of an amount of time in response to receipt of the first signal.

6. The method as recited in claim 1 further comprising the data acquisition device operating a timer that measures an amount of time that the first signal is received; and recording a measurement of that amount of time.

7. The method as recited in claim 1 wherein transferring the first identifier comprises transmitting the first identifier via another wireless signal from the data acquisition device to a computer.

8. The method as recited in claim 1 wherein transferring the first identifier comprises:
sending a wireless interrogation signal to the data acquisition device; and
the data acquisition device responding to the interrogation signal by transmitting the first identifier to the computer via another wireless signal.

9. The method as recited in claim 1 wherein transferring the first identifier comprises transmitting the first identifier via one of a cellular telephone connection, a land line telephone connection, and an Internet connection.

10. The method as recited in claim 1 wherein:
the data acquisition device transmits a second wireless signal; and
the identification device responds to receiving the second wireless signal by emitting the first wireless signal.

11. The method as recited in claim 1 wherein the data acquisition device is assigned a second identifier and further comprises transferring the second identifier from the data acquisition device to the computer.

12. The method as recited in claim 1 further comprising the computer using the first identifier to determine information related to attendance of the healthcare worker near the patient.

13. The method as recited in claim 1 further comprising preparing a patient treatment report using information transferred to the computer.

14. A system for monitoring services provided by a healthcare worker at a residence of a medical patient, said system comprising:
an identification device for placement in the residence wherein the identification device wirelessly emits a first wireless signal providing a first identifier;
a data acquisition device, to be carried by a healthcare worker, for receiving the first wireless signal whenever the data acquisition device is proximate to the residence and responding to receipt of the first wireless signal by recording the first identifier, the data acquisition device emitting a data signal that carries the first identifier; and
a computer that receives the data signal carrying the first identifier.

15. The system as recited in claim 14 wherein the identification device periodically emits the first wireless signal.

16. The system as recited in claim 14 further comprising the data acquisition device recording date and time of day that the first signal is received.

17. The system as recited in claim 14 wherein the data acquisition device records an indication of an amount of time in response to receipt of the first signal.

18. The system as recited in claim 14 wherein the data signal is a wireless signal.

19. The system as recited in claim 14 further comprising:
an interrogator for sending a wireless interrogation signal to the data acquisition device; and
the data acquisition device responding to the interrogation signal by transmitting the first identifier to the computer via another wireless signal.

20. The system as recited in claim 14 wherein the computer that receives the data signal via one of a cellular telephone connection, a land line telephone connection and an Internet connection.

21. The system as recited in claim 14 wherein:
the data acquisition device transmits a second wireless signal; and
the identification device responds to receiving the second wireless signal by emitting the first wireless signal.

22. The system as recited in claim 14 wherein the data acquisition device is assigned a second identifier and the data signal also carries the second identifier.

23. The system as recited in claim 14 wherein the computer uses the first identifier to determine information related to attendance of the healthcare worker near the patient.

24. The system as recited in claim 14 wherein the computer prepares a patient treatment record using information received from the data acquisition device.
